(19) United States
(12) Patent Application Publication
(10) Pub. No.: US 2026/0281433 A1
(43) Pub. Date: Sep. 17, 2026

(54) PREDICTION SCHEME FOR MESHES WITH IRREGULAR SURFACE SAMPLING

(71) Applicant: GOOGLE LLC, Mountain View, CA (US)

(72) Inventors: Igor Vytyaz, Folsom, CA (US); Ondrej Stava, San Jose, CA (US)

(21) Appl. No.: 19/563,577

(22) Filed: Mar. 11, 2026

Related U.S. Application Data
(60) Provisional application No. 63/772,170, filed on Mar. 14, 2025.

(51) Int. Cl. H04N 19/597; H04N 19/91

(52) U.S. Cl. CPC H04N 19/597; H04N 19/91

(57) ABSTRACT

Methods and systems for compressing and decompressing vertex data in a mesh include identifying a target vertex to be compressed and a plurality of neighboring vertices. A first predicted position for the target vertex is determined based on the positions of the neighboring vertices, a normal vector for a plane defined by the neighboring vertices is determined, and a dominant coordinate among the three coordinates is identified based on the normal vector. Correction values for the other two coordinates are determined based on the first predicted position and actual coordinate values. A second predicted position for the dominant coordinate is calculated by plugging the actual values of the other two coordinates into the plane equation. A final correction value is determined, and the vertex is encoded using the three correction values. This prediction scheme leverages local planarity to improve accuracy and efficiency for irregularly sampled surfaces.

### CROSS REFERENCE TO RELATED APPLICATION

This application claims the benefit of U.S. Provisional Application No. 63/772,170, filed Mar. 14, 2025, the disclosure of which is incorporated herein by reference in its entirety.

### BACKGROUND

In three-dimensional systems, digital representations of three-dimensional objects are frequently generated using meshes, which include vertices, edges, and faces that define the shape of an object. One objective when generating these representations is to use as little space as possible for efficient storage and transmission of the three-dimensional data. To achieve this, mesh compression and decompression techniques are employed. These techniques reduce the amount of data required to describe the mesh without significant loss of detail. However, challenges can arise in compressing certain types of meshes, particularly those with irregular or complex topologies, which can limit the effectiveness of standard compression algorithms and necessitate more advanced prediction schemes.

### SUMMARY

Disclosed herein are methods and systems for compressing and decompressing three-dimensional (3D) data, such as 3D mesh data. In one aspect, implementations provide a prediction scheme specifically designed to improve the compression of 3D meshes that have smooth surfaces but are irregularly sampled, such as those generated by 3D scanning of physical objects. Unlike existing prediction schemes that assume a regular geometric structure (e.g., forming a parallelogram), the disclosed implementations leverage the local planarity of a mesh surface to improve prediction accuracy. By identifying a dominant coordinate direction from a normal vector of a geometric constraint such as a plane defined by neighboring vertices and using the actual coordinate values of the other two dimensions to snap the prediction of the dominant coordinate to that plane, the disclosed implementations significantly reduce the prediction offset. This approach is particularly useful in volumetric visual media applications where high compression rates are required to conserve storage and transmission bandwidth while maintaining the integrity of complex, irregularly sampled surfaces.

In some implementations, a method for compressing 3D data includes identifying a target vertex with three actual coordinate values and determining a first predicted position based on the positions of a plurality of neighboring vertices. A normal vector is determined for a geometric constraint such as a plane defined by these neighboring vertices, and a first coordinate is identified, typically the coordinate corresponding to the dominant component of the normal vector, to be the snapped coordinate. The method involves determining correction values for the other two coordinates based on the first predicted position and the actual values. Subsequently, a second predicted position for the first coordinate is determined by plugging the actual values of the two coordinates into the plane equation. A final correction value for the first coordinate is calculated from this second predicted position. The target vertex is then encoded using these three correction values. Corresponding decompression methods and systems are also provided to reconstruct the vertex position by reversing this snapping process using the decoded correction values and the calculated plane.

### BRIEF DESCRIPTION OF THE DRAWINGS

Example implementations will become more fully understood from the detailed description given herein below and the accompanying drawings, wherein like elements are represented by like reference numerals, which are given by way of illustration only and thus are not limiting of the example implementations.

FIG. 1A illustrates an encoder/decoder system according to at least one example implementation.

FIG. 1B illustrates an encoder system according to at least one example implementation.

FIG. 1C illustrates a decoder system according to at least one example implementation.

FIG. 2A illustrates an example geometric construct for a mesh with regular sampling according to at least one example implementation.

FIG. 2B illustrates an example geometric construct for a mesh with irregular sampling according to at least one example implementation.

FIG. 3 illustrates predicting a position of a vertex to encode within a geometric construct according to at least one example implementation.

FIG. 4 is a block diagram of a method for compressing a vertex within a geometric construct according to at least one example implementation.

FIG. 5 is a block diagram of a method for decompressing a vertex within a geometric construct according to at least one example implementation.

It should be noted that these figures are intended to illustrate the general characteristics of methods, and/or structures utilized in certain example implementations and to supplement the written description provided below. These drawings are not, however, to scale and may not precisely reflect the precise structural or performance characteristics of any given implementation and should not be interpreted as defining or limiting the range of values or properties encompassed by example implementations. For example, the positioning of modules and/or structural elements may be reduced or exaggerated for clarity. The use of similar or identical reference numbers in the various drawings is intended to indicate the presence of a similar or identical element or feature.

### DETAILED DESCRIPTION

Implementations for prediction schemes for meshes with irregular surface sampling are described herein. Efficient storage and transmission of three-dimensional (3D) data often rely on mesh compression techniques, but standard algorithms struggle with irregular mesh topologies, as standard prediction schemes, such as parallelogram prediction, fail to provide accurate vertex position estimates for meshes that are smooth but irregularly sampled. Existing methods often assume a regular geometric structure, and they tend to produce large prediction offsets when applied to 3D scans of physical objects, leading to inefficient compression and increased storage or bandwidth requirements. To resolve this, the disclosed implementations leverage the local planarity of a mesh surface to snap vertex coordinates to a calculated neighborhood geometric constraint, such as a plane. By identifying a dominant coordinate direction from a normal vector of the geometric constraint and using the actual values of the other two dimensions to calculate the final coordinate, the system significantly reduces prediction error and improves compression efficiency. The implementations disclosed are applicable to various data compression scenarios, including mesh compression and 3D data processing. For instance, in online gaming, smaller 3D model files for characters and environments mean faster loading times and smoother gameplay, as less data needs to be transmitted over the network. In virtual and augmented reality (VR/AR), this allows for more complex and detailed virtual worlds to run efficiently on portable devices, such as standalone headsets. The disclosed implementations can also speed up the loading of 3D product viewers on e-commerce websites, allowing a customer to inspect a pair of shoes or a piece of furniture from all angles very quickly. As such, the disclosed implementations provide a more accurate and more efficient prediction method that better anticipates the surface shape of a 3D model, thus reducing the amount of data needed to store or send it.

In modern computing systems, particularly in the field of 3D graphics and modeling, digital representations of physical or virtual objects are important. These 3D representations are often constructed using a polygonal mesh, which is a collection of vertices, edges, and faces that collectively define the shape and surface of an object. The efficiency of storing and transmitting these 3D models is important, as uncompressed mesh data can consume significant memory and bandwidth resources. Consequently, the use of mesh compression techniques is important in reducing the data footprint of these models, thus enabling faster transmission over networks and more efficient storage on various media. Effective compression is particularly important in improving applications such as virtual and augmented reality, online gaming, and scientific visualization, where large and complex 3D models are often handled in real-time. For these applications, it is important to generate digital representations as fast as possible (considering processing power and situational timelines). It is also advantageous to minimize code complexity (e.g., to affect the processing time).

Common types of meshes include quad meshes, polygonal meshes, and triangular meshes, each characterized by the number of edges forming their constituent faces. The regular and predictable structure of certain meshes lends itself to various compression technologies, such as predictive coding, where the position of a vertex is predicted based on the positions of its already-processed neighbors. However, achieving high compression rates for certain types of data presents a significant technical problem. While existing prediction schemes, such as parallelogram prediction, work effectively for meshes with regular surface sampling, they often fail to provide accurate vertex position estimates for meshes with irregular surface sampling. Irregular surface sampling is common in meshes generated by 3D scanning of physical objects, where vertex positions do not adhere to a rigid geometric grid. For these irregularly sampled meshes, the assumption of a regular geometric structure (e.g., forming a parallelogram) results in a technical problem where the predicted position is significantly displaced from the actual position. This lack of accuracy leads to a technical problem of large prediction offsets, which in turn results in low compression rates and increased storage and transmission costs.

The aforementioned technical problems are further exacerbated by the difficulty of accurately modeling complex, curved surfaces that lack regular connectivity. Standard algorithms often struggle with these irregular topologies, leading to a technical problem of inefficient data handling for volumetric visual media. Conventional solutions have fallen short because they rely on fixed geometric assumptions that do not account for the local planarity of a smooth surface when the sampling is irregular. These inadequate methods are unable to minimize the magnitude of correction data required, representing a missed opportunity for achieving high-efficiency compression in applications such as digital twins or real-time 3D visualization.

To address these technical problems, the present disclosure provides a technical solution in the form of a prediction scheme designed to improve the compression of 3D meshes that have smooth surfaces that are irregularly sampled. Instead of assuming a regular grid, the technical solution leverages the local planarity of a mesh surface to improve prediction accuracy. In some implementations, the technical solution involves calculating a neighborhood geometric constraint, such as a plane, from previously processed vertices and snapping the target vertex coordinates to this plane. This may involve identifying a dominant coordinate direction from a normal vector of the plane and using the actual coordinate values of the other two dimensions to calculate the final coordinate, thus significantly reducing prediction error.

In some implementations, the technical solution involves a multi-step snapping process. First, a predicted position may be determined using a standard method, and a normal vector for the local plane may be calculated. A specific coordinate (e.g., X, Y, or Z) may then be identified as the snapped coordinate. In an example, this is the coordinate corresponding to the dominant component of the normal vector (e.g., the largest component). Correction values for the other two coordinates may then be determined based on the first predicted position and the actual values. Subsequently, a second predicted position for the snapped coordinate may be determined by plugging the actual values of the two known coordinates into the plane equation. A final correction value for the snapped coordinate can then be calculated from this second predicted position. This process effectively transforms the 3D mesh data into a compact form by ensuring the prediction is more closely aligned with the actual surface.

The disclosed implementations provide several advantageous technical effects. A primary technical effect is a significant improvement in compression rates for irregularly sampled 3D meshes, such as irregularly sampled triangular meshes. By providing more accurate vertex position predictions through the snapping mechanism, the magnitude of the required correction values is substantially reduced. Smaller correction values require fewer bits to store or transmit, directly resulting in the technical effect of conserved storage space and reduced transmission bandwidth. Another technical effect is the optimization of 3D scan data for storage in cloud environments and low-bandwidth transmission of complex digital twins.

Furthermore, the technical solution provides the technical effect of reduced error sensitivity. By choosing the coordinate to snap based on the dominant component of the plane normal, the system ensures that the mathematical calculations remain numerically stable and accurate. This results in the technical effect of a more robust compression framework that can handle various surface orientations without a loss in performance. The technical solution also yields the technical effect of maintaining the integrity of complex surfaces while reducing the data footprint, enabling smoother interaction with high-resolution 3D models.

At least one additional technical effect of the disclosed prediction scheme is that compression libraries can include prediction schemes configured to predict vertex attributes for meshes with irregular sampling surfaces. These prediction schemes deliver more accurate predictions and higher compression rates for meshes with irregular sampling surfaces compared to the currently available prediction schemes available for meshes.

In practice, the implementations discussed herein may be used in the high-efficiency compression of volumetric visual media, such as 3D images and videos captured for virtual and augmented reality applications. By reducing the data required for complex character models and environments, the technical solution allows for faster loading times and reduced latency in real-time streaming scenarios. The compression of 3D scan data is also highly applicable to industrial sectors where digital twins of physical assets may need to be transmitted over limited-bandwidth networks for monitoring and maintenance.

Additionally, the techniques are valuable for e-commerce platforms utilizing 3D product viewers. By compressing detailed meshes of products such as apparel or furniture, the disclosed implementations ensure that high-quality representations can be loaded quickly on mobile devices. In medical and scientific visualization, the technical solution facilitates the efficient sharing and archiving of high-precision geometric models derived from 3D scans, allowing researchers to collaborate more effectively without being hindered by large file sizes.

The term “vertex” as used herein refers generally to a point in a 3D space that defines a position on a surface or within a volume of a geometric construct. In an example, a vertex refers to a point in a 3D space that is defined by its coordinates, which may be an (x, y, z) value. As such, a vertex may provide the spatial position for a specific point on the surface of a 3D model. Moreover, beyond position, a vertex may store other data such as color, normal vectors, texture data, and the like.

Vertices are often connected to each other by edges to form polygons such as triangles. The polygons collectively form a mesh that defines an object's shape and/or surface. The term “polygonal mesh” as used herein refers generally to a collection of vertices, edges, and faces that define the shape and surface of a 3D object. An edge may refer to a connection (e.g., a straight line) between two vertices within a geometric mesh. In the context of mesh compression and prediction schemes, an edge is often represented as a vector derived from the positions of the two vertices it connects. For example, the edge from vertex d to vertex e can be represented by the vector e-d. The edge vectors may be used to describe the mesh's connectivity and to model grid line curvature and spacing to predict the position of other vertices.

The term “irregular surface sampling” as used herein refers generally to a distribution of vertices on a surface where the connectivity or spacing of the vertices does not follow a regular or uniform geometric pattern.

The term “geometric construct” as used herein refers generally to a data structure that represents the spatial geometry of a three-dimensional object by defining positional coordinates for a set of points that delineate the object's surface or volume. In various implementations, a geometric construct may be represented as a point cloud or a polygonal mesh. In an example, a plane may serve as a local geometric construct defined by a set of neighboring vertices, providing a mathematical boundary to which other vertex coordinates can be snapped or projected to improve prediction accuracy during data compression.

The term “plane normal” or “normal vector” as used herein refers generally to a vector that is perpendicular to the surface of a plane defined by a set of points or vertices. In certain implementations, the plane normal is used as a factor in determining the order of coordinate processing and the specific mathematical formulation for the snapped prediction. For example, the plane normal is utilized in a global assessment to determine the applicability of the prediction scheme across an entire mesh. An implementation may evaluate the local planarity of the mesh surface by examining the plane normals of adjacent pairs of faces across common edges. By determining the angular difference or sharpness between these normals, the system can calculate an averaged smoothness measure for the mesh. If the normals are nearly parallel across the majority of edges, indicating a smooth surface, the system may enable the snapping process for that mesh. Conversely, if the plane normals frequently show large angular deviations, the implementation may bypass the snapping mechanism to avoid introducing prediction errors on a rough surface. Additionally, a local condition may be applied where the plane normal is used to ensure the neighborhood vertices provide a robust geometric signal. For example, if the magnitude of the normal components or the resolution of the vertices falls below a criterion, such as a threshold, the system may fall back to a traditional parallelogram prediction.

The term “correction value” as used herein refers generally to a difference between an actual coordinate value of a vertex and a predicted coordinate value of the vertex.

The term “quantization” as used herein refers generally to the process of mapping a large set of input values to a smaller set, such as converting floating-point coordinates to integer values. Quantization may be used as a precursor to the prediction and compression processes, ensuring that vertex positions and other attributes are represented in a consistent format across different computing environments. In such implementations, vertex positions are typically converted from floating-point values to integer values. This integer-based approach ensures that mathematical operations, such as computing the normal of a plane or mapping a point to a plane, remain consistent across various hardware architectures.

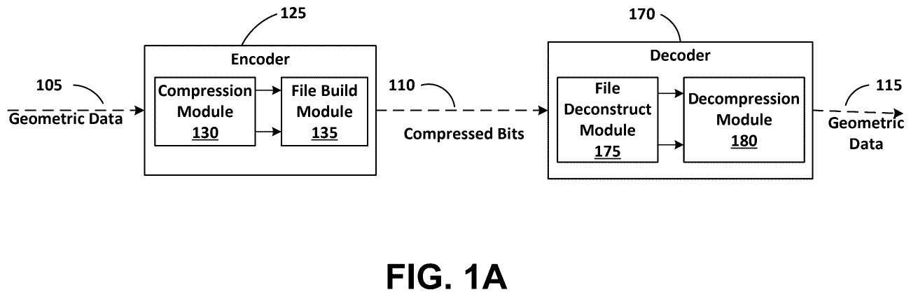

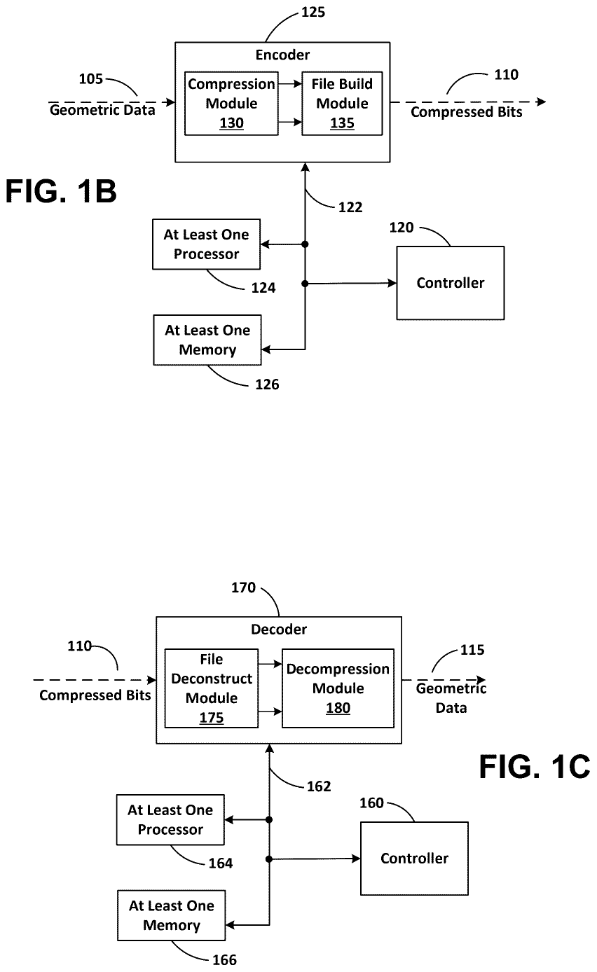

FIG. 1A illustrates an encoder/decoder system according to at least one example implementation. As shown in FIG. 1A, the encoder/decoder system can include an encoder 125 and a decoder 170. The encoder 125 can include a compression module 130 and a file build module 135. The decoder 170 can include a file deconstruct module 175 and a decompression module 180. The encoder 125 can be configured to generate compressed bits 110 based on geometric data 105. The decoder 170 can be configured to generate geometric data 115 based on compressed bits 110.

Geometric data 115 can be reconstructed geometric data corresponding to (representing, associated with, and the like) geometric data 105. The geometric data can be 3D data, such as 3D mesh data.

The compression module 130 is configured to compress geometric data using one or more prediction schemes configured to predict vertex attributes for vertices in mesh(es). For example, compression module 130 can include a memory configured to store a plurality of compression schemes that utilize a plurality of prediction schemes. At least one of the compression schemes can include a prediction scheme configured to predict vertices for meshes with smooth surface(s) that are irregularly sampled.

In some implementations, the compression module 130 includes a scheme for determining when a condition is met to use the prediction scheme configured for meshes with smooth surface(s) that are irregularly sampled. For example, the compression module 130 can include a scheme for determining when the mesh has a smooth surface and/or is irregularly sampled. The scheme can make a determination based on a global condition at a global level for a 3D mesh that indicates whether the prediction scheme configured for meshes that are irregularly sampled should be used for the whole mesh. This global condition may be determined by evaluating a combination of surface smoothness (e.g., sharpness) and sampling irregularity across the mesh. In one implementation, the system utilizes an elliptical classifier to define a decision boundary based on a sharpness parameter and a regularity parameter. If the combined measures of averaged sharpness and averaged regularity for the mesh fall within the bounds of this elliptical classifier, the snapping process is enabled. This ensures that the specialized prediction scheme is only applied to meshes that exhibit the specific geometric characteristics, smooth but irregularly sampled, where the snapping mechanism provides a measurable compression gain over traditional parallelogram prediction.

In some implementations, the determination can be made at a local level for a vertex in the mesh. Other prediction schemes can be used where the criteria for the prediction scheme for meshes with smooth surface(s) that are irregularly sampled are not met. One example of evaluating surface smoothness involves examining the edges in the mesh, identifying the two triangles across an edge, and then determining whether the triangles are in the same plane and/or the level of sharpness across the edge. The sharpness of the edges can be averaged across the mesh. The averaged sharpness can then be compared to a criterion such as a threshold to determine whether the mesh has a smooth surface. One example of evaluating sampling irregularity involves inspecting pairs of triangles across the edge to see how close they are to forming parallelograms. In some examples, that indication of regularity is averaged across the mesh. The local determination can be made by examining a vertex neighborhood and determining whether it is sampled with a sufficiently high resolution for applying the prediction scheme.

In some implementations, determining which prediction scheme to use and/or determining whether a compression scheme should be used may involve the use of quantization. In some examples, quantization is used as a precursor to the prediction and compression processes, ensuring that vertex positions and other attributes are represented in a consistent format across different computing environments. This may involve first converting the vertex positions from floating-point values to integer values. This integer-based approach ensures that mathematical operations, such as computing the normal of a plane or mapping a point to a plane, remain consistent across various hardware architectures. However, the precision of quantization can influence the performance of prediction schemes. For example, the accuracy of the snapping mechanism described herein may depend on the geometric signal-to-noise ratio. When vertices are close together, for instance, when they are separated by a small number of quantization steps, the relative error introduced by quantization noise can become more significant. In such cases, performing complex geometric calculations, such as plane equations, can result in larger prediction errors. To address this, implementations may utilize a local condition to decide whether to apply the snapping process for a specific vertex based on the geometric signal-to-noise ratio. This decision can be based on the resolution of the vertex neighborhood relative to the quantization grid. In one example, the system calculates a measure of the neighborhood resolution as the sum of L1 norms of the edges of a nearby triangle. If this resolution value falls below a specific criterion (e.g., a threshold value), such as a value between 20 and 50 quantization steps, the system may determine that the geometric signal is not reliable for snapping due to potential numerical instability and instead fall back to a traditional prediction method. By ensuring the neighborhood perimeter or edge length exceeds this threshold, the implementation ensures that the resulting plane equation avoids division by small numbers, which reduces error sensitivity and maintains numerical stability during the snapping process.

In some implementations, other prediction schemes can be used along with the prediction scheme for meshes that are irregularly sampled. Moreover, a starting vertex in a mesh may have no prediction scheme applied. The compression module 130 can be configured to communicate a compressed mesh and an indication of the compression scheme and/or the prediction scheme used on each vertex to the file build module 135. The file build module 135 can be configured to generate a file based on a plurality of entropy-encoded values representing compressed geometric data 105 and the compression scheme and/or the prediction scheme used to compress geometric data 105. The generated file may include a header or other metadata including information about the geometric construct (e.g., point cloud, mesh, and the like), the compression scheme and/or the prediction scheme (e.g., variables associated with the compression module 130), and the like. The generated file may be stored in a local memory and/or communicated to another device (e.g., a device separate from and communicatively coupled to the device that encoded the geometric construct) as the compressed bits 110.

The file deconstruct module 175 can be configured to receive a file including compressed bits 110 representing a stream of data corresponding to a geometric construct (e.g., point cloud, mesh, and the like). The compressed bits were previously compressed using a prediction scheme configured to predict vertices in a mesh (e.g., in a triangular mesh). The file deconstruct module 175 can be configured to determine the prediction schemes used to compress the geometric construct and a plurality of entropy-encoded values representing compressed geometric data 105. The file deconstruct module 175 can be configured to communicate the prediction schemes and the plurality of entropy-encoded values representing compressed geometric data 105 to the decompression module 180. The decompression module 180 can be configured to decompress the plurality of entropy-encoded values representing compressed geometric data 105 using the prediction schemes. The decompressed data can be geometric data 115 or reconstructed geometric data corresponding to (representing, associated with, and the like) geometric data 105.

FIG. 1B illustrates an encoder system according to at least one example implementation. In the example of FIG. 1B, an encoder system may be at least one computing device and should be understood to represent virtually any computing device configured to perform the methods described herein. As such, the encoder system constitutes a special-purpose computing device, and its standard hardware components are specially configured by computer-executable instructions to implement the techniques described herein, or different or future versions thereof, thereby transforming what would be a general-purpose computer into a specialized and more efficient machine for 3D mesh compression. By way of example, the encoder system is illustrated as including at least one processor 124, as well as at least one memory 126 (e.g., a non-transitory computer-readable storage medium).

The at least one processor 124 may be utilized to execute instructions stored on the at least one memory 126, so as to thereby implement the various features and functions described herein, or additional or alternative features and functions. Of course, the at least one processor 124 and the at least one memory 126 may be utilized for various other purposes. In particular, the at least one memory 126 may be understood to represent an example of various types of memory and related hardware and software that might be used to implement any one of the modules described herein.

As shown in FIG. 1B, the encoder system includes the at least one processor 124, the at least one memory 126, a controller 120, and an encoder 125. The at least one processor 124, the at least one memory 126, the controller 120, and the encoder 125 are communicatively coupled via bus 122.

The at least one processor 124 may be configured to execute computer instructions associated with the controller 120 and/or the encoder 125. The at least one processor 124 may be a shared resource. For example, the encoder 125 may be an element of a larger system (e.g., a 2D or 3D scanner). Therefore, the at least one processor 124 may be configured to execute computer instructions associated with other elements (e.g., controlling laser scanner position or movement) within the larger system.

The at least one memory 126 may be configured to store data and/or information associated with the encoder 125. For example, the at least one memory 126 may be configured to store buffers, including, for example, buffers storing geometric data, portions of the geometric data, positions of data points in the geometric data, a number of data points associated with a portion of the geometric data, and/or the like. For example, the at least one memory 126 may be configured to store buffers, including, for example, data associated with a geometric construct (e.g., a mesh, a point cloud, and the like).

The controller 120 may be configured to generate various control signals and communicate the control signals to various blocks in the encoder 125. The controller 120 may be configured to generate the control signals in accordance with the methods described herein. The controller 120 may be configured to control the encoder 125 to encode data associated with a geometric construct according to example implementations as described herein. For example, the controller 120 may generate and communicate a control signal indicating a compression scheme in the compression module 130. For example, the controller 120 may generate and communicate a control signal indicating the prediction scheme that should be used to predict vertices in a triangular mesh (or meshes).

FIG. 1C illustrates a decoder system according to at least one example implementation. In the example of FIG. 1C, a decoder system may be at least one computing device and should be understood to represent virtually any computing device configured to perform the methods described herein. As such, the decoder 170 may be understood to include various standard components which may be utilized to implement the techniques described herein, or different or future versions thereof. By way of example, the decoder 170 is illustrated as including at least one processor 164, as well as at least one memory 166 (e.g., a non-transitory computer-readable storage medium).

As shown in FIG. 1C, the decoder system includes the at least one processor 164, the at least one memory 166, a controller 160, and a decoder 170. The at least one processor 164, the at least one memory 166, the controller 160, and the decoder 170 are communicatively coupled via bus 162.

The at least one processor 164 may be utilized to execute instructions stored on the at least one memory 166, so as to thereby implement the various features and functions described herein, or additional or alternative features and functions. Of course, the at least one processor 164 and the at least one memory 166 may be utilized for various other purposes. In particular, the at least one memory 166 may be understood to represent an example of various types of memory and related hardware and software which might be used to implement any one of the modules described herein. According to example implementations, the encoder system of FIG. 1B and the decoder system of FIG. 1C may be included in the same larger system. Further, the at least one processor 164 and the at least one processor 124 may be the same at least one processor, and the at least one memory 166 and the at least one memory 126 may be the same at least one memory. Still further, the controller 160 and the controller 120 may be the same controller.

The at least one processor 164 may be configured to execute computer instructions associated with the controller 160 and/or the decoder 170. The at least one processor 164 may be a shared resource. For example, the decoder system may be an element of a larger system (e.g., a mobile device). Therefore, the at least one processor 164 may be configured to execute computer instructions associated with other elements (e.g., web browsing or wireless communication) within the larger system.

The at least one memory 166 may be configured to store data and/or information associated with the decoder system. For example, the at least one memory 166 may be configured to store buffers, including, for example, buffers storing geometric data, portions of the geometric data, positions of data points in the geometric data, a number of data points associated with a portion of the geometric data, and/or the like. For example, the at least one memory 166 may be configured to store buffers, including, for example, data associated with a geometric construct.

The controller 160 may be configured to generate various control signals and communicate the control signals to various blocks in the decoder system. The controller 160 may be configured to generate the control signals in accordance with the methods described above. The controller 160 may be configured to control the decoder 170 to decode data associated with a geometric construct according to example implementations described herein. For example, the controller 160 may generate and communicate a control signal indicating a prediction scheme configured to predict vertices in a triangular mesh (or meshes).

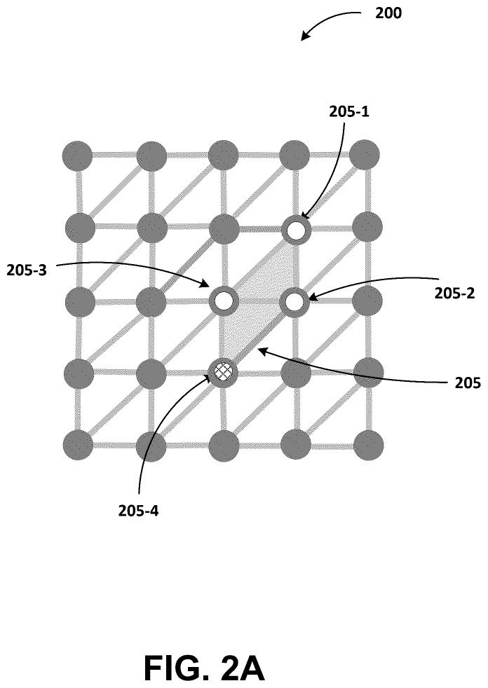

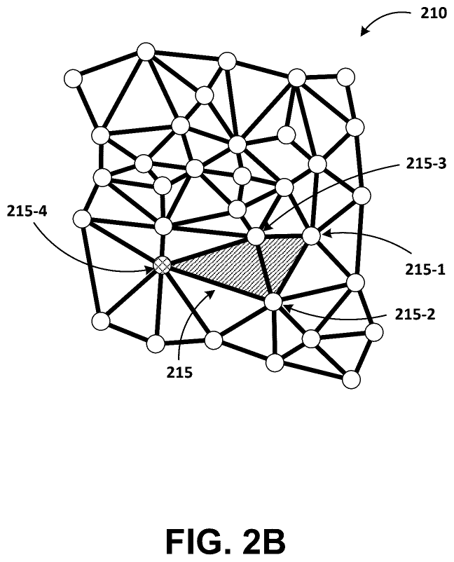

FIG. 2A illustrates an example geometric construct for a mesh with regular sampling according to at least one example implementation. A geometric construct is a data structure that represents the geometry of a 3D object, wherein the data structure includes positional coordinates for a set of points that define the object's surface or volume. In the example of FIG. 2A, a geometric construct 200 (e.g., a mesh, a point cloud, and the like), which is a triangular mesh, is depicted. In a triangular mesh (or grid), each vertex can be connected to six edges. Vertices on an edge of the mesh can be connected to less than six edges. The geometric construct 200 is a mesh that has been sampled in a regular manner. As a result, pairs of adjacent faces are substantially coplanar and are close to forming parallelograms, such as the parallelogram 205. When vertices of a mesh form parallelograms, existing prediction schemes, such as the parallelogram prediction scheme, generate reasonably accurate predictions. Such prediction schemes can be used to predict the position of a vertex, such as vertex 205-4, relatively accurately, when the positions of neighboring vertices 205-1, 205-2, and 205-3 are known. However, when a mesh has an irregularly sampled surface, neighboring vertices may not form shapes that resemble parallelograms.

FIG. 2B illustrates an example geometric construct for a mesh with irregular sampling, according to at least one example implementation. In the example of FIG. 2B, a geometric construct 210 (e.g., a mesh, a point cloud, and the like), which is a triangular mesh with irregular sampling, is depicted. Because the geometric construct 210 has an irregularly sampled surface, neighboring vertices, such as the vertices 215-1, 215-2, 215-3, and 215-4, do not form a parallelogram. Instead, they form the shape 215, in which the vertex 215-4 is located in a position that is displaced from a position that would have formed a parallelogram. As a result, if an existing prediction scheme, such as the parallelogram prediction scheme, is used to predict the position of vertex 215-4, the offset between the predicted position and the actual position of the vertex 215-4 would be large, resulting in a low compression rate. To improve the compression rate for such irregularly sampled meshes, implementations disclosed herein make use of a prediction scheme that delivers more accurate predictions for irregularly sampled meshes.

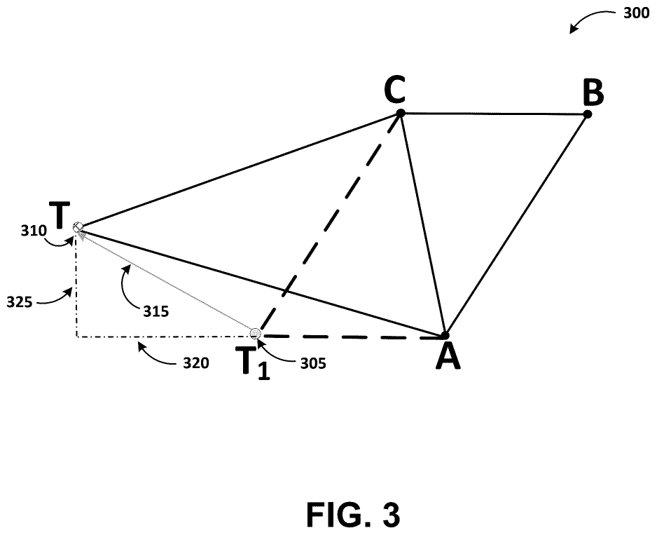

FIG. 3 illustrates predicting a position of a vertex to encode within a geometric construct, according to at least one example implementation. FIG. 3 is used to illustrate a prediction scheme for predicting the position of a vertex in an irregularly sampled triangular mesh. In the example of FIG. 3, the vertex labeled T is the target vertex, or in other words, the currently visited vertex or the vertex being encoded/decoded. The target vertex has three coordinates (X, Y, and Z) with actual coordinate values. The vertices labeled A, B, and C are considered neighboring vertices of T, which form the grouping 300. The encoder has access to values for the actual positions of A, B, and C. In a decoder, the vertices labeled A, B, and C have been visited, and their vertex attributes (e.g., positions) are known. Put another way, the vertices A, B, and C are considered decompressed vertices from the point of view of the decoder. In a decoder, positions of vertices A, B, and C may have been determined using existing prediction schemes or using the prediction scheme disclosed herein.

To predict the position of the target vertex T (T=[XT, YT, ZT]), an existing prediction scheme, such as the parallelogram prediction scheme or Hexagon prediction scheme, can be used. The parallelogram prediction scheme utilizes the positions of neighboring vertices A, B, and C that form the triangle ABC to predict the position of vertex T based on an assumption that the grouping 300 forms a parallelogram (parallelogram ABCT1), the neighboring vertices and the predicted position of the vertex T1 being the vertices of the parallelogram. However, because the vertex T belongs to a mesh having an irregularly sampled surface, the predicted position 305 of vertex T is different from the actual position 310 of vertex T. Thus, a difference, represented by vector 315, may be calculated for vertex T. The difference represents a vector 315 from the predicted position 305 to the actual position 310. The vector 315 has three coordinates X, Y, and Z. Because the triangles ABC and ACT are irregular, the difference (e.g., correction value) between the predicted position T1 and the target position of vertex T is large. The encoder records the differences. As a result, larger differences result in a higher memory footprint. To improve the accuracy of the predicted location and reduce the memory footprint needed to store the difference, some implementations identify the dominant component (e.g., largest component) of the neighborhood plane normal vector and select that component for computing the prediction coordinate. This is because the prediction component corresponding to the dominant component is likely to be computed more accurately when using the plane equation. By identifying the largest component of the normal vector and snapping that specific coordinate, the implementation ensures that the resulting plane equation avoids division by small numbers. This specific selection reduces error sensitivity and maintains numerical stability during the snapping process, ensuring that the predicted results remain accurate and contribute to a higher overall compression rate.

In an example, the disclosed technique includes computing the normal vector of a plane that contains the triangle ABC. Because the predicted position 305 of vertex T (located at T1) was calculated using a parallelogram prediction scheme, positions of vertices A, B, and C, as well as the predicted position 305, lie on the computed plane or are substantially coplanar.

Components of the computed normal plane are then examined to identify which direction the normal plane is pointing more towards. Put another way, a coordinate (e.g., one of the X, Y, or Z directions) is identified as contributing more to the normal vector than the other two coordinates. This component is identified as being the largest component of the normal vector (e.g., the component having the dominant absolute value). For example, if the normal vector is computed to be [−0.1, 0.2, −0.95], the Z-component is identified as the largest component because its magnitude (0.95) is greater than the magnitudes of the X (0.1) and Y (0.2) components. The coordinate identified by this direction is treated differently when calculating the difference between the predicted position 305 and the actual position 310 (e.g., the correction value). For example, if the plane normal is pointing mostly in the Z-axis direction, then the encoder first calculates and encodes the correction values for the X and Y coordinates (denoted as ΔX_{T}_{₁} and ΔY_{T}_{₁}, and depicted as corrections 320 and 325 in FIG. 3). By snapping the coordinate corresponding to the largest normal component, the implementation ensures that the resulting plane equation avoids division by small numbers, which reduces error sensitivity and maintains numerical stability during the snapping process. The corrections ΔX_{T}_{₁}, and ΔY_{T}_{₁} can be calculated based on actual coordinate values of the coordinates, which may be denoted as X_{T} and Y_{T}. This is because, at this point, before the vertex is encoded, the encoder knows the actual position of the vertex.

In the decoder, the corrections (e.g., ΔX_{T}_{₁}, and ΔY_{T}_{₁}) are decoded and used to determine the actual position of two coordinates of the target vertex T (X and Y coordinates). Thus, in the encoder, the differences between the predicted position and the actual position of vertex T can be calculated for two of the three coordinates, and in the decoder, the predicted position of the vertex T is first calculated based on the neighboring vertices, and then the actual position of the vertex T can be calculated for two of the three coordinates using the differences for those coordinates and the predicted position. In the decoder, the two coordinates are identified using the normal plane, which can be computed as a plane that contains the triangle ABC and the predicted position of the vertex T. The decoder then determines the second predicted position based on the plane and the actual values of the two coordinates. The actual value for the third coordinate is determined in the decoder based on the predicted value for the third coordinate of the second predicted position and the correction value for the third coordinate.

The correction value for the remaining coordinate can be determined by using a predicted value that is assumed to lie on the plane of the ABC triangle and the predicted position T1, which was previously computed. Thus, the known coordinates (e.g., X_{T} and Y_{T}) are used in the ABC plane equation such that the predicted location of the unknown coordinate (e.g., denoted as Z_{T}_{₂}) lies on the plane. As a result, the second predicted position (not shown) of the vertex T has the actual values of the first two coordinates and lies on the ABC triangle plane. This predicted position can be written as expression (1):

$$T 2 = [ {X}_{T} , {Y}_{T} , {Z}_{{T}_{2}} ] \qquad ( 1 )$$

Once the predicted position for the unknown coordinate has been calculated, the offset between the predicted location and the actual location for the unknown coordinate (referred to as the correction value) can be computed. This offset can be written as expression (2):

$$Δ {Z}_{{T}_{2}} = {Z}_{T} - {Z}_{{T}_{2}} \qquad ( 2 )$$

The three correction values can then be used by the encoder as the encoded vertex. Because the correction values are smaller than the actual coordinates, the use of these correction values results in data compression. Because two actual components (coordinates) of the target vertex T (e.g., X_{T} and Y_{T}) are used to compute the offset for the last component (e.g., ΔZ_{T}_{₂}), the offset (correction value) for the remaining component is likely to be smaller than the predicted vertex component (e.g., AZT). This results in predictions that are more accurate and more compact for meshes with smooth surfaces and irregular sampling, such as those generated by 3D scanning of objects. This is achieved by first selecting an appropriate correction component (X, Y, or Z) based on the computed normal plane.

In some implementations, the encoder is optimized to leverage the increased accuracy of the snapped prediction. The encoder may utilize four separate residual contexts to improve compression efficiency: one context for each of the non-snapped X, Y, and Z coordinate residuals, and a specialized fourth context reserved for the snapped coordinate residuals. Because the snapping process may result in a residual distribution for the first coordinate that is significantly sharper and more concentrated around zero compared to the other coordinates, assigning these residuals to a dedicated context allows the encoder to achieve higher compression gains for the mesh data.

In some implementations, the snapping process may be performed as a vector projection of the first predicted position onto the neighborhood plane. Rather than solving for a single coordinate component, the system may translate the first predicted position along a projection vector, such as the normal vector, until the vertex intersects the neighborhood plane. In such cases, all three coordinates (X, Y, and Z) may receive minor adjustments, but the adjustment is weighted such that the coordinate component most aligned with the normal vector undergoes the largest displacement. This multi-coordinate snapping ensures surface adherence while distributing quantization error across all axes.

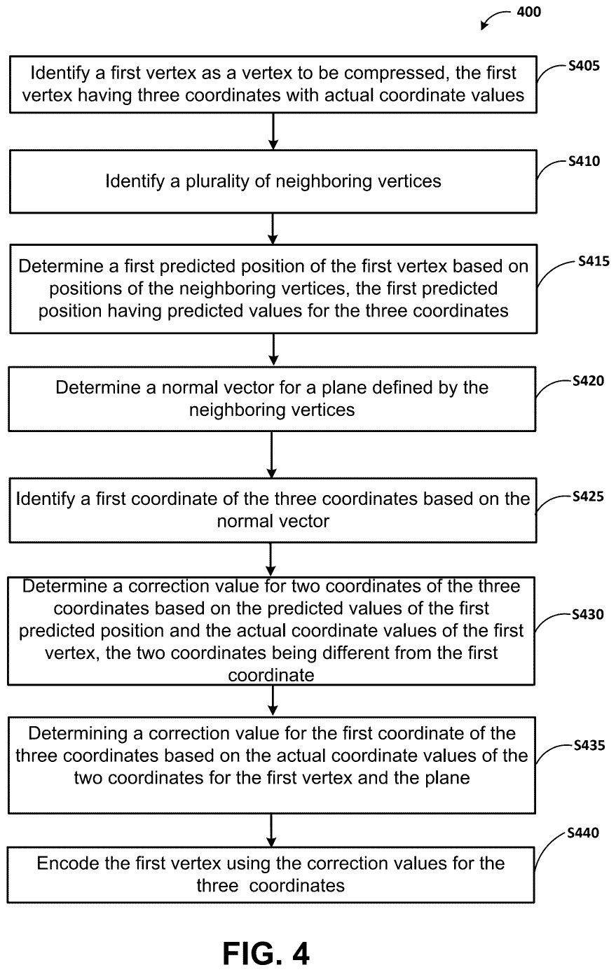

FIG. 4 is a block diagram of a method 400 for compressing a vertex within a geometric construct, according to at least one example implementation. The method 400 may be used on any vertex in a geometric construct such as a triangular grid (mesh, point cloud, and the like) that has a smooth and/or irregularly sampled surface.

As shown in FIG. 4, in step S405, an encoder may identify a first vertex as a vertex to be compressed. This may occur during an encoding operation. The first vertex may have three coordinates (X, Y, and Z) with actual coordinate values. In step S410, the encoder may identify a plurality of neighboring vertices to the first vertex.

In step S415, the encoder may determine a first predicted position of the first vertex based on positions of the neighboring vertices, where the first predicted position has predicted values for the three coordinates. The first predicted position may be determined using a known prediction mechanism. In step S420, the encoder may determine a normal vector for a plane defined by the neighboring vertices. In an example, the normal vector is computed for a plane that contains the neighboring vertices and the first predicted position.

In step S425, the decoder may identify the first coordinate of the three coordinates based on the normal vector. This may be done by identifying the coordinate corresponding to the largest component of the normal vector. In step S430, the encoder may determine a correction value for two other coordinates of the first vertex based on the predicted values of the first predicted position and the actual coordinate values of the first vertex. The two coordinates are different from the first coordinate.

In step S435, the encoder may determine a correction value for the first coordinate of the first vertex based on the actual coordinate values of the two coordinates for the three coordinates and the plane. This can involve determining a second predicted position for the first vertex based on the plane and the actual coordinate values of the two coordinates for the first vertex and determining the correction value for the first coordinate of the first vertex based on a predicted value for the first coordinate of the second predicted position and an actual value for the first coordinate of the first vertex. In step S440, the encoder may encode the first vertex using the correction values of the three coordinates. The encoder may encode the first vertex with an indication of the type of prediction scheme used to encode the first vertex.

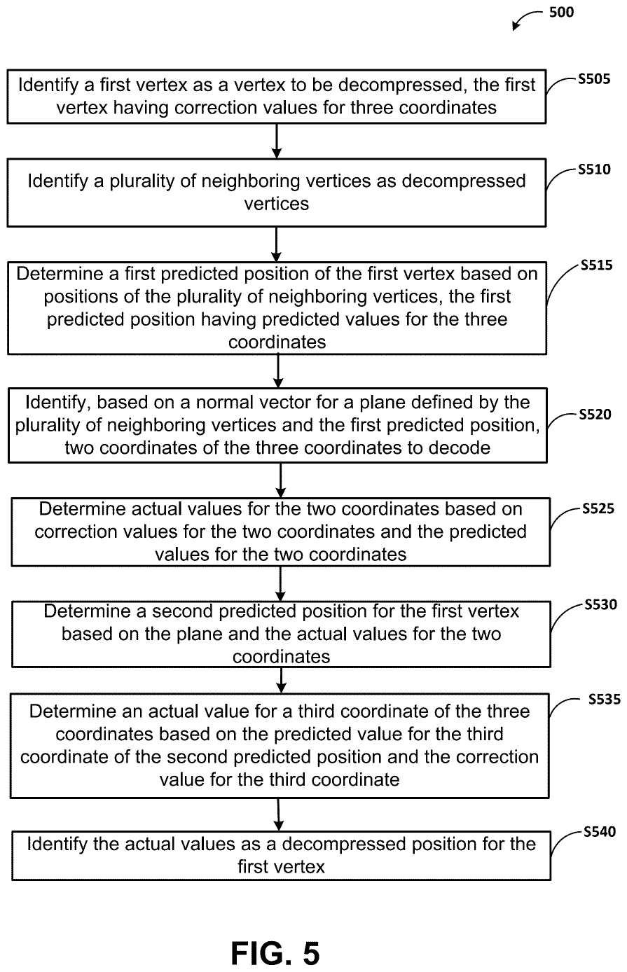

FIG. 5 is a block diagram of a method 500 for decompressing a vertex within a geometric construct according to at least one example implementation. As shown in FIG. 5, in step S505, a decoder may identify a first vertex as a vertex to be decompressed. The first vertex may have correction values for three coordinates (X, Y, and Z).

In step S510, the decoder may identify a plurality of neighboring vertices as decompressed vertices. In step S515, the decoder may determine a first predicted position of the first vertex based on positions of the plurality of neighboring vertices, where the first predicted position has predicted values for the three coordinates. In step S520, the decoder may identify, based on a normal vector for a plane defined by the plurality of neighboring vertices and the first predicted position, two coordinates of the three coordinates to decode.

In step S525, the decoder may determine actual values for the two coordinates based on correction values for the two coordinates and the predicted values for the two coordinates. In step S530, the decoder may determine a second predicted position for the first vertex based on the plane and the actual values for the two coordinates. In step S535, the decoder may determine an actual value for a third coordinate of the three coordinates based on the predicted value for the third coordinate of the second predicted position and the correction value for the third coordinate. In step S540, the decoder may identify the actual values as a decompressed position for the first vertex.

Example implementations can include a non-transitory computer-readable storage medium comprising instructions stored thereon that, when executed by at least one processor, are configured to cause a computing system to perform any of the methods described above. Example implementations can include an apparatus including means for performing any of the methods described above. Example implementations can include an apparatus including at least one processor and at least one memory including computer program code, the at least one memory and the computer program code configured to, with the at least one processor, cause the apparatus at least to perform any of the methods described above.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (a LED (light-emitting diode), or OLED (organic LED), or LCD (liquid crystal display) monitor/screen) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

A number of implementations have been described. Nevertheless, it will be understood that various modifications may be made without departing from the spirit and scope of the specification.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

While certain features of the described implementations have been illustrated as described herein, many modifications, substitutions, changes and equivalents will now occur to those skilled in the art. It is, therefore, to be understood that the appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

While example implementations may include various modifications and alternative forms, implementations thereof are shown by way of example in the drawings and will herein be described in detail. It should be understood, however, that there is no intent to limit example implementations to the particular forms disclosed, but on the contrary, example implementations are to cover all modifications, equivalents, and alternatives falling within the scope of the claims. Like numbers refer to like elements throughout the description of the figures.

Some of the above example implementations are described as processes or methods depicted as flowcharts. Although the flowcharts describe the operations as sequential processes, many of the operations may be performed in parallel, concurrently, or simultaneously. In addition, the order of operations may be rearranged. The processes may be terminated when their operations are completed, but may also have additional steps not included in the figure. The processes may correspond to methods, functions, procedures, subroutines, subprograms, etc.

Methods discussed above, some of which are illustrated by the flow charts, may be implemented by hardware, software, firmware, middleware, microcode, hardware description languages, or any combination thereof. When implemented in software, firmware, middleware, or microcode, the program code or code segments to perform the necessary tasks may be stored in a machine or computer readable medium such as a storage medium. A processor(s) may perform the necessary tasks.

Specific structural and functional details disclosed herein are merely representative for purposes of describing example implementations. Example implementations, however, may be embodied in many alternate forms and should not be construed as limited to only the implementations set forth herein.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of example implementations. As used herein, the term and/or includes any and all combinations of one or more of the associated listed items.

It will be understood that when an element is referred to as being connected or coupled to another element, it can be directly connected or coupled to the other element or intervening elements may be present. In contrast, when an element is referred to as being directly connected or directly coupled to another element, there are no intervening elements present. Other words used to describe the relationship between elements should be interpreted in a like fashion (e.g., between versus directly between, adjacent versus directly adjacent, etc.).

The terminology used herein is for the purpose of describing particular implementations only and is not intended to be limiting of example implementations. As used herein, the singular forms a, an and the are intended to include the plural forms as well, unless the context clearly indicates otherwise. It will be further understood that the terms comprises, comprising, includes and/or including, when used herein, specify the presence of stated features, integers, steps, operations, elements and/or components, but do not preclude the presence or addition of one or more other features, integers, steps, operations, elements, components and/or groups thereof.

It should also be noted that in some alternative implementations, the functions/acts noted may occur out of the order noted in the figures. For example, two figures shown in succession may in fact be executed concurrently or may sometimes be executed in the reverse order, depending upon the functionality/acts involved.

Unless otherwise defined, all terms (including technical and scientific terms) used herein have the same meaning as commonly understood by one of ordinary skill in the art to which example implementations belong. It will be further understood that terms, e.g., those defined in commonly used dictionaries, should be interpreted as having a meaning that is consistent with their meaning in the context of the relevant art and will not be interpreted in an idealized or overly formal sense unless expressly so defined herein.

Portions of the above example implementations and corresponding detailed description are presented in terms of software, or algorithms and symbolic representations of operation on data bits within a computer memory. These descriptions and representations are the ones by which those of ordinary skill in the art effectively convey the substance of their work to others of ordinary skill in the art. An algorithm, as the term is used here, and as it is used generally, is conceived to be a self-consistent sequence of steps leading to a desired result. The steps are those requiring physical manipulations of physical quantities. Usually, though not necessarily, these quantities take the form of optical, electrical, or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

In the above illustrative implementations, reference to acts and symbolic representations of operations (e.g., in the form of flowcharts) that may be implemented as program modules or functional processes include routines, programs, objects, components, data structures, etc., that perform particular tasks or implement particular abstract data types and may be described and/or implemented using existing hardware at existing structural elements. Such existing hardware may include one or more Central Processing Units (CPUs), digital signal processors (DSPs), application-specific-integrated-circuits, field programmable gate arrays (FPGAs) computers or the like.

It should be borne in mind, however, that all of these and similar terms are to be associated with the appropriate physical quantities and are merely convenient labels applied to these quantities. Unless specifically stated otherwise, or as is apparent from the discussion, terms such as processing or computing or calculating or determining of displaying or the like, refer to the action and processes of a computer system, or similar electronic computing device, that manipulates and transforms data represented as physical, electronic quantities within the computer system's registers and memories into other data similarly represented as physical quantities within the computer system memories or registers or other such information storage, transmission or display devices.

Note also that the software implemented aspects of the example implementations are typically encoded on some form of non-transitory program storage medium or implemented over some type of transmission medium. The program storage medium may be magnetic (e.g., a floppy disk or a hard drive) or optical (e.g., a compact disk read only memory, or CD ROM), and may be read only or random access. Similarly, the transmission medium may be twisted wire pairs, coaxial cable, optical fiber, or some other suitable transmission medium known to the art. The example implementations are not limited by these aspects of any given implementation.

Lastly, it should also be noted that whilst the accompanying claims set out particular combinations of features described herein, the scope of the present disclosure is not limited to the particular combinations hereafter claimed, but instead extends to encompass any combination of features or implementations herein disclosed irrespective of whether or not that particular combination has been specifically enumerated in the accompanying claims at this time.

The following paragraphs provide various examples of the implementations disclosed herein.

In one aspect, a method for compressing three-dimensional data includes identifying a first vertex as a vertex to be compressed, the first vertex having three coordinates with actual coordinate values; identifying a plurality of neighboring vertices; and determining a first predicted position of the first vertex based on positions of the plurality of neighboring vertices, the first predicted position having predicted values for the three coordinates. The method further includes determining a geometric constraint defined by the plurality of neighboring vertices; identifying a first coordinate of the three coordinates based on the geometric constraint; determining correction values for two coordinates of the three coordinates based on the predicted values of the first predicted position and the actual coordinate values of the first vertex, the two coordinates being different from the first coordinate; determining a correction value for the first coordinate of the three coordinates based on the actual coordinate values of the two coordinates and the plane; and compressing the first vertex using the correction values for the three coordinates.

In another aspect, the plurality of neighboring vertices are vertices of a parallelogram formed with the first predicted position of the first vertex.

In another aspect, the three-dimensional data represents a mesh having an irregularly sampled surface.

In another aspect, the method includes determining that the three-dimensional data represents a mesh having an irregularly sampled surface.

In another aspect, identifying the first coordinate includes identifying a coordinate corresponding to a dominant component of a normal vector for the geometric constraint.

In another aspect, the geometric constraint is a plane and a normal vector for the plane is determined such that the plurality of neighboring vertices and the first predicted position of the first vertex are substantially coplanar.

In another aspect, determining the correction value for the first coordinate of the first vertex includes determining a second predicted position for the first vertex based on the plane and the actual coordinate values of the two coordinates for the first vertex; and determining the correction value for the first coordinate of the first vertex based on a predicted value for the first coordinate of the second predicted position and an actual value for the first coordinate of the first vertex.

In another aspect, the method includes receiving geometric data including data relating to at least one of a triangular mesh, a quad mesh or a polygonal mesh.

In another aspect, the method includes compressing the correction values for the three coordinates using entropy coding, wherein the correction value for the first coordinate is encoded using a first statistical context, and the correction values for the two coordinates are encoded using at least one second statistical context different from the first statistical context.

In another aspect, the method includes determining a measure of neighborhood resolution for the plurality of neighboring vertices, wherein the first coordinate of the three coordinates is identified and the correction value for the first coordinate is determined in response to determining that the measure of neighborhood resolution exceeds a threshold value.

In one aspect, a method for decompressing three-dimensional data includes identifying a first vertex as a vertex to be decompressed, the first vertex having correction values for three coordinates; identifying a plurality of neighboring vertices as decompressed vertices; and determining a first predicted position of the first vertex based on positions of the plurality of neighboring vertices, the first predicted position having predicted values for the three coordinates. The method further includes identifying, based on a geometric constraint defined by the plurality of neighboring vertices and the first predicted position, two coordinates of the three coordinates to decode; determining actual values for the two coordinates based on correction values for the two coordinates and the predicted values for the two coordinates; determining a second predicted position for the first vertex based on the geometric constraint and the actual values for the two coordinates; determining an actual value for a third coordinate of the three coordinates based on the predicted value for the third coordinate of the second predicted position and the correction value for the third coordinate; and identifying the actual values as a decompressed position for the first vertex.

In another aspect, the plurality of neighboring vertices are vertices of a parallelogram formed with the first predicted position.

In another aspect, identifying the two coordinates includes identifying the two coordinates as not being a dominant component of a normal vector for the geometric constraint.

In another aspect, identifying the third coordinate includes identifying a coordinate corresponding to a dominant component of a normal vector for the geometric constraint.

In another aspect, the geometric constraint is a plane and a normal vector for the geometric constraint is determined such that the plurality of neighboring vertices and the first predicted position of the first vertex are substantially coplanar.

In one aspect, a computing device includes at least a processor and a memory storing instructions that, when executed by the processor, cause the computing device to perform operations including determining at least one of a smoothness measure or a regularity measure for a three-dimensional (3D) mesh, the 3D mesh including a plurality of vertices; determining that at least one of the smoothness measure or the regularity measure satisfies a criterion; responsive to determining that the smoothness measure or the regularity measure satisfies the criterion, identifying a target vertex from among the plurality of vertices; identifying a neighborhood plane for the target vertex; selecting a coordinate component of the target vertex as corresponding to a dominant direction of a normal vector of the neighborhood plane; predicting the coordinate component based on actual values of non-selected coordinate components and the neighborhood plane; and compressing a value representing a difference between the predicted coordinate component and an actual value of the coordinate component.

In another aspect, the neighborhood plane includes a plurality of neighboring vertices.

In another aspect, determining that the smoothness measure or the regularity measure satisfies the criterion includes applying an elliptical classifier to at least one of the smoothness measure or the regularity measure.

In another aspect, the criterion is a snapping threshold.

In another aspect, predicting the coordinate component based on actual values of non-selected coordinate components and the neighborhood plane includes inserting the actual values of non-selected coordinate components into an equation for the neighborhood plane.

What is claimed is:

1. A method for compressing three-dimensional data comprising:
identifying a first vertex as a vertex to be compressed, the first vertex having three coordinates with actual coordinate values;
identifying a plurality of neighboring vertices;
determining a first predicted position of the first vertex based on positions of the plurality of neighboring vertices, the first predicted position having predicted values for the three coordinates;
determining a geometric constraint defined by the plurality of neighboring vertices;
identifying a first coordinate of the three coordinates based on the geometric constraint;
determining correction values for two coordinates of the three coordinates based on the predicted values of the first predicted position and the actual coordinate values of the first vertex, the two coordinates being different from the first coordinate;
determining a correction value for the first coordinate of the three coordinates based on the actual coordinate values of the two coordinates and the geometric constraint; and
compressing the first vertex using the correction values for the three coordinates.

2. The method of claim 1, wherein the plurality of neighboring vertices are vertices of a parallelogram formed with the first predicted position of the first vertex.

3. The method of claim 1, wherein the three-dimensional data represents a mesh having an irregularly sampled surface.

4. The method of claim 1, further comprising determining that the three-dimensional data represents a mesh having an irregularly sampled surface.

5. The method of claim 1, wherein identifying the first coordinate comprises identifying a coordinate corresponding to a dominant component of a normal vector for the geometric constraint.

6. The method of claim 1, wherein the geometric constraint is a plane and a normal vector for the plane is determined such that the plurality of neighboring vertices and the first predicted position of the first vertex are substantially coplanar.

7. The method of claim 6, wherein determining the correction value for the first coordinate of the first vertex comprises:
determining a second predicted position for the first vertex based on the plane and the actual coordinate values of the two coordinates for the first vertex; and
determining the correction value for the first coordinate of the first vertex based on a predicted value for the first coordinate of the second predicted position and an actual value for the first coordinate of the first vertex.

8. The method of claim 1, further comprising receiving geometric data including data relating to at least one of a triangular mesh, a quad mesh or a polygonal mesh.

9. The method of claim 1, further comprising compressing the correction values for the three coordinates using entropy coding, wherein the correction value for the first coordinate is encoded using a first statistical context, and the correction values for the two coordinates are encoded using at least one second statistical context different from the first statistical context.

10. The method of claim 1, further comprising determining a measure of neighborhood resolution for the plurality of neighboring vertices, wherein the first coordinate of the three coordinates is identified and the correction value for the first coordinate is determined in response to determining that the measure of neighborhood resolution exceeds a threshold value.

11. A method for decompressing three-dimensional data comprising:
identifying a first vertex as a vertex to be decompressed, the first vertex having correction values for three coordinates;
identifying a plurality of neighboring vertices as decompressed vertices;
determining a first predicted position of the first vertex based on positions of the plurality of neighboring vertices, the first predicted position having predicted values for the three coordinates;
identifying, based on a geometric constraint defined by the plurality of neighboring vertices and the first predicted position, two coordinates of the three coordinates to decode;
determining actual values for the two coordinates based on correction values for the two coordinates and the predicted values for the two coordinates;
determining a second predicted position for the first vertex based on the geometric constraint and the actual values for the two coordinates;
determining an actual value for a third coordinate of the three coordinates based on the predicted value for the third coordinate of the second predicted position and the correction value for the third coordinate; and
identifying the actual values as a decompressed position for the first vertex.

12. The method of claim 11, wherein the plurality of neighboring vertices are vertices of a parallelogram formed with the first predicted position.

13. The method of claim 11, wherein identifying the two coordinates comprises identifying the two coordinates as not being a dominant component of a normal vector for the geometric constraint.

14. The method of claim 11, wherein identifying the third coordinate comprises identifying a coordinate corresponding to a dominant component of a normal vector for the geometric constraint.

15. The method of claim 11, wherein the geometric constraint is a plane and a normal vector for the plane is determined such that the plurality of neighboring vertices and the first predicted position of the first vertex are substantially coplanar.

16. A computing device comprising:
at least a processor; and
a memory storing instructions that, when executed by the processor, cause the computing device to perform operations including:
determining at least one of a smoothness measure or a regularity measure for a three-dimensional (3D) mesh, the 3D mesh including a plurality of vertices;
determining that at least one of the smoothness measure or the regularity measure satisfies a criterion;
responsive to determining that the smoothness measure or the regularity measure satisfies the criterion, identifying a target vertex from among the plurality of vertices;
identifying a neighborhood plane for the target vertex;
selecting a coordinate component of the target vertex as corresponding to a dominant direction of a normal vector of the neighborhood plane;
predicting the coordinate component based on actual values of non-selected coordinate components and the neighborhood plane; and
compressing a value representing a difference between the predicted coordinate component and an actual value of the coordinate component.

17. The computing device of claim 16, wherein the neighborhood plane includes a plurality of neighboring vertices.

18. The computing device of claim 16, wherein determining that the smoothness measure or the regularity measure satisfies the criterion includes applying an elliptical classifier to at least one of the smoothness measure or the regularity measure.

19. The computing device of claim 16, wherein the criterion is a snapping threshold.

20. The computing device of claim 16, wherein predicting the coordinate component based on actual values of non-selected coordinate components and the neighborhood plane includes inserting the actual values of non-selected coordinate components into an equation for the neighborhood plane.
